(19) United States
(12) Patent Application Publication
(10) Pub. No.: US 2025/0076258 A1
(43) Pub. Date: Mar. 6, 2025

(54) ACOUSTICAL METHOD FOR MICROBUBBLE OSCILLATORY RADIUS ESTIMATION AND ACOUSTIC EMISSION DETECTION

(71) Applicant: Georgia Tech Research Corporation, Atlanta, GA (US)

(72) Inventors: Hohyun Lee, Atlanta, GA (US); Costas Arvanitis, Atlanta, GA (US)

(21) Appl. No.: 18/821,711

(22) Filed: Aug. 30, 2024

Related U.S. Application Data
(60) Provisional application No. 63/536,284, filed on Sep. 1, 2023.

(51) Int. Cl. G01N 29/14; G01N 29/44

(52) U.S. Cl. CPC G01N 29/14; G01N 29/4454; G01N 2291/02433

(57) ABSTRACT

Systems and methods for determining microbubble dynamics. The method may comprise introducing at least one microbubble into a vessel. The method may also comprise providing ultrasound waves through an outer surface of the vessel and to at least a portion of the at least one microbubble, wherein the ultrasound waves cause the at least one microbubble to oscillate and emit acoustic waves. The method may further comprise receiving, via at least one receiver, the acoustic waves and generating acoustic emission data based on the acoustic waves. The method may further comprise determining, based at least in part on the acoustic emission data, an acoustic emission frequency of the at least one microbubble. The method may also comprise determining, based at least in part on the acoustic emission frequency, at least one dynamic property of the at least one microbubble.

### CROSS-REFERENCE TO RELATED APPLICATIONS

This application claims the priority benefit of U.S. Provisional Patent Application Ser. No. 63/536,284, filed Sep. 1, 2023, which is hereby incorporated by reference in its entirety.

### STATEMENT REGARDING FEDERALLY SPONSORED RESEARCH OR DEVELOPMENT

This invention was made with government support under Agreement No. CA239039, awarded by the National Institutes of Health. The government has certain rights in the invention.

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates generally to systems and methods, and more particularly to focused ultrasound (FUS) systems combined with microbubble (MB) ultrasound systems and methods thereof.

### 2. Description of Related Art

Ultrasound has emerged as a novel modality for the treatment and imaging of many conditions, including brain diseases and disorders. When enhanced by circulating microbubble contrast agents—for example lipid, albumin, or polymer-shelled gas pockets that scaher sound and vibrate in response to incident ultrasound—ultrasound can enable a range of new therapeutic interventions and open new possibilities for imaging. Current ultrasound systems, however, are limited in both imaging and targeting.

Microbubbles (MBs) are ultrasound contrast agents (USCA) that are widely used for ultrasound (US) imaging in tissues. MBs' contrasting ability comes from their i) non-linear oscillatory behavior and ii) high resonant but linear scattering cross section, which ultimately enhances US image quality. Apart from their contributions in US imaging, recent studies also discovered the therapeutic potential of MBs when combined with focused ultrasound (FUS). This therapeutic strategy, known as MB-FUS, is an emerging technology that provides a physical method to reversibly increase the permeability of the blood-brain barrier (BBB), which is a major obstacle in delivery of therapeutic agents to the brain. Despite the promising findings in both pre-clinical and clinical settings, the exact mechanism of MB-FUS assisted BBB opening is uncertain, although it is related to MBs' dynamics (i.e., MBs' oscillation) in the brain vessels. MB-FUS systems provides a drug delivery process that is non-invasive, is reversible, and is able to target physical openings of a blood-brain barrier (BBB). While this method can be used to estimate the oscillation state of MBs (e.g., stable oscillations or MB collapse), current methods fall short on providing information about the radius change (R(t)) information, which is critical for estimating the exerted mechanical stress on the cells and tissue and bridging the gap between MB dynamics and corresponding biological effects.

Therefore, there is a need for systems and methods that resolve the problems with estimating the oscillation state of microbubbles that overcome the current limitations.

### SUMMARY OF THE INVENTION

Briefly described, according to exemplary embodiments of the present invention, systems and methos of an innovative system for determining microbubble dynamics. In some embodiments, the present inventions determine at least one dynamic property of at least one microbubble.

In an exemplary embodiment of the present disclosure, a method may comprise introducing at least one microbubble into a vessel. In various embodiments, the method may further comprise providing ultrasound waves through an outer surface of the vessel and to at least a portion of the at least one microbubble. The ultrasound waves may cause the at least one microbubble to oscillate and emit at least one acoustic waves. In various embodiment, the method may further comprise receiving, via at least one receiver, the at least one acoustic wave. In various embodiments, the method may further comprise generating acoustic emission data based on the at least one acoustic wave. In various embodiments, the method may further comprise determining, based at least in part on the acoustic emission data, an acoustic emission frequency of the at least one microbubble. In various embodiments, the method may also comprise determining, based at least in part on the acoustic emission frequency, at least one dynamic property of the at least one microbubble. The at least one dynamic property of the at least one microbubble may be one or more of a change, with respect to time, of a radius, pressure, phase, frequency, amplitude, or a combination thereof.

In various embodiments, the frequency at which the at least one microbubble oscillates may be dependent on one or more of a microbubble size, gas properties of a microbubble, surrounding fluid, transmitted frequency from the waveform generator, or a combination thereof. In various embodiments, the received acoustic waves may comprise a first set of the acoustic waves during a first period of time and a second set of acoustic waves during a second period of time.

In various embodiments, the determination of at least one dynamic property of the at least one microbubble may comprise implementing an algorithm that may be independent from properties of the at least one microbubble. In various embodiments, the oscillation of the at least one microbubble may be one or more of linear oscillation, nonlinear oscillation, or a combination thereof, wherein the oscillation of the at least one microbubble causes a change in the radius of the at least one microbubble. In various embodiments, the determination of the at least one dynamic property of the at least one microbubble may comprise converting at least a portion of the acoustic emission data to a frequency domain. In various embodiments, the determination of the at least one dynamic property of the at least one microbubble may also comprise determining, based at least in part on the acoustic emission data in the frequency domain, a pressure propagation of the at least one oscillating microbubble. In various embodiments, the determination of the at least one dynamic property of the at least one microbubble may also comprise determining, based at least in part on the pressure propagation, at least one oscillating microbubble radius change.

In various embodiments, the determination of the at least one dynamic property of the at least one microbubble may also comprise determining, based at least in part on the at least one oscillating microbubble radius change, an average pressure for at least one microbubble. In various embodiments, the method may further comprise determining, based at least in part on a determination of the radius change of at least one oscillating microbubble, the at least one dynamic property of the at least one microbubble.

In various embodiments, the method may further comprise identifying one or more type of phase delay due to a spatial distribution of the at least one microbubble. The one or more type of phase delay may be due to one or more of a propagation source, propagation of the acoustic emission data, or a combination thereof. In various embodiments, the method may further comprise positioning the waveform generator and at least one receiver opposite of each other. The position of the waveform generator and the at least one receiver may result in constructive propagation from the at least one microbubble.

In yet another exemplary embodiment of the present disclosure a system is provided for determining microbubble dynamics. In various embodiments, the system may comprise a transducer configured to provide ultrasound waves and cause at least one microbubble to oscillate. In various embodiments, the system may further comprise a receiver configured to receive signals produced by the ultrasound waves interacting with microbubbles. In various embodiments, the system may further comprise a processing platform comprising at least one processor. The processing platform may be in communication with the transducer and the receiver. In various embodiments, the system may further comprise a controller in communication with the processing platform comprising at least one memory modules storing programmed instructions thereon.

In various embodiments, the at least one memory modules storing programmed instructions thereon that, when executed by the controller, cause the system to introduce at least one microbubble into a vessel. In various embodiments, the programmed instructions, when executed by the controller, may further cause the system to generate acoustic emission data based on the acoustic waves. In various embodiments, the programmed instructions, when executed by the controller, may further cause the system to determine, based at least in part on the acoustic emission data, an acoustic emission frequency of the at least one microbubble. In various embodiments, the programmed instructions, when executed by the controller, may further cause the system to determine, based at least in part on the acoustic emission frequency, at least one dynamic property of the at least one microbubble. The at least one dynamic property of the at least one microbubble may be one or more of a change, with respect to time, of a radius, pressure, phase, frequency, amplitude, or a combination thereof.

In various embodiments, the frequency at which the at least one microbubble oscillates may be dependent on one or more of a microbubble size, gas properties of a microbubble, surrounding fluid, transmitted frequency from the waveform generator, or a combination thereof. In various embodiments, the received acoustic waves may comprise a first set of the acoustic waves during a first period of time and a second set of acoustic waves during a second period of time. In various embodiments, determining at least one dynamic property of the at least one microbubble may comprise implementing an algorithm that is independent from properties of the at least one microbubble. In various embodiments, the oscillation of the at least one microbubble may be one or more of linear oscillation, nonlinear oscillation, or a combination thereof, wherein the oscillation of the at least one microbubble causes a change in the radius of the at least one microbubble.

In various embodiments, the at least one memory module further comprises programmed instructions that, when executed by the controller, further causes the system to convert at least a portion of the acoustic emission data to a frequency domain. In various embodiments, the at least one memory module further comprises programmed instructions that, when executed by the controller, further causes the system to determine, based at least in part on the acoustic emission data in the frequency domain, a pressure propagation of the at least one oscillating microbubble. In various embodiments, the at least one memory module further comprises programmed instructions that, when executed by the controller, further causes the system to determine, based at least in part on the pressure propagation, at least one oscillating microbubble radius change.

In various embodiment, the at least one memory module further comprises programmed instructions that, when executed by the controller, further causes the system to determine, based at least in part on the at least one oscillating microbubble radius change, an average pressure for at least one microbubble. In various embodiments, the at least one memory module further comprises programmed instructions that, when executed by the controller, further causes the system to determine, based at least in part on a determination of the at least one oscillating microbubble radius change, the at least one dynamic property of the at least one microbubble.

In various embodiments, the at least one memory module further comprises programmed instructions that, when executed by the controller, further causes the system to identify one or more type of phase delay due to a spatial distribution of the at least one microbubble. The one or more type of phase delay may be due to one or more of a propagation source, propagation of the acoustic emission data, or a combination thereof. In various embodiments, the at least one memory module further comprises programmed instructions that, when executed by the controller, further causes the system to position the waveform generator and at least one receiver opposite of each other. The position of the waveform generator and the at least one receiver may result in constructive propagation from the at least one microbubble.

These and other aspects, features, and benefits of the claimed invention(s) will become apparent from the following detailed written description of the preferred embodiments and aspects taken in conjunction with the following drawings, although variations and modifications thereto may be affected without departing from the spirit and scope of the novel concepts of the disclosure.

### BRIEF DESCRIPTION OF THE DRAWINGS

Implementations, features, and aspects of the disclosed technology are described in detail herein and are considered a part of the claimed disclosed technology. Other implementations, features, and aspects can be understood with reference to the following detailed description, accompanying drawings, and claims. Wherever possible, the same reference numbers are used throughout the drawings to refer to the same or like members of an embodiment. Reference will now be made to the accompanying figures and flow diagrams, which are not necessarily drawn to scale.

FIG. 1 illustrates an exemplary schematic of a system including components that can employ the methods described herein in accordance with various embodiments of the present disclosure.

FIG. 2A illustrates an exemplary experimental setup of a system using a controller in accordance with various embodiments of the present disclosure.

FIG. 2B illustrates an exemplary experimental setup of a system using a controller in accordance with various embodiments of the present disclosure.

FIG. 2C illustrates an exemplary experimental setup of a system using a controller in accordance with various embodiments of the present disclosure.

FIG. 3 illustrates an exemplary schematic of a focused ultrasound process in accordance with various embodiments of the present disclosure.

FIG. 4 graphically illustrates propagation and backpropagation results of a system with the controller in accordance with various embodiments of the present disclosure.

FIG. 5A graphically illustrates an acoustic emission efficiency for microbubbles in accordance with various embodiments of the present disclosure.

FIG. 5B graphically illustrates measurements of microbubble size distribution and monodisperse microbubble size distribution in accordance with various embodiments of the present disclosure.

FIG. 6A illustrates exemplary optical images of at least one microbubble in accordance with various embodiments of the present disclosure.

FIG. 6B graphically illustrates results of optical measurements of a microbubble and microbubble radius dynamics estimation in accordance with various embodiments of the present disclosure.

FIG. 7A illustrates an exemplary schematic of a system identifying the location of at least one microbubble in accordance with various embodiments of the present disclosure.

FIG. 7B graphically illustrates a representation of a destructive function as a function of a receiver angle in accordance with various embodiments of the present disclosure.

FIG. 7C graphically illustrates a representation of an ideal position of a receiver and source for purely constructive interference in accordance with various embodiments of the present disclosure.

FIG. 8 graphically illustrates a representation of an ideal position of a receiver and source for purely constructive interference in accordance with various embodiments of the present disclosure.

FIG. 9A illustrates an exemplary monodisperse microbubble in accordance with various embodiments of the present disclosure.

FIG. 9B graphically illustrates pressure propagation of at least one 2 μm diameter microbubble in accordance with various embodiments of the present disclosure.

FIG. 9C illustrates an exemplary graphically representation of a reconstructed microbubble radius dynamics using inverse calculation algorithm with initial radius 1 μm in accordance with various embodiments of the present disclosure.

FIG. 10 illustrates an exemplary method flow diagram in accordance with various embodiments of the present disclosure.

### DETAILED DESCRIPTION OF THE INVENTION

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Also, in describing the preferred exemplary embodiments, terminology will be resorted to for the sake of clarity. It is intended that each term contemplates its broadest meaning as understood by those skilled in the art and includes all technical equivalents that operate in a similar manner to accomplish a similar purpose.

As used in the specification and the appended claims, the singular forms “a,” “an” and “the” include plural referents unless the context clearly dictates otherwise. References to a composition containing “a” constituent is intended to include other constituents in addition to the one named.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named element, system, compound, member, particle, or method step is present in the composition or element or system or article or method, but does not exclude the presence of other compounds, materials, particles, method steps, even if the other such compounds, material, particles, method steps have the same function as what is named.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter. Additionally, the components described herein may apply to any other component within the disclosure. Merely discussing a feature or component in relation to one embodiment does not preclude the feature or component from being used or associated with another embodiment.

It is also to be understood that the mention of one or more method steps does not imply that the methods steps must be performed in a particular order or preclude the presence of additional method steps or intervening method steps between the steps expressly identified.

To facilitate an understanding of the principles and features of the disclosure, various illustrative embodiments are explained below. In particular, the presently disclosed subject matter is described in the context of systems and methods for imaging and focusing using ultrasound and, more particularly, to estimation of dynamic properties of at least one microbubble in a focused ultrasound systems utilizing microbubble. In some examples, the systems and methods may be described in the context of treating patients, including human and other animal patients. The present disclosure, however, is not so limited and can be applicable in outer contexts. For example, some examples of the present disclosure may improve upon imaging and targeting in inanimate systems. Additionally, reference is made herein to ultrasounds techniques for targeting through bone, including a human skull. It will be understood that such disclosure is illustrative, as the imaging and focusing techniques can be applied equally to other surfaces. Accordingly, when the present disclosure is described in the context of estimating dynamic properties of at least one microbubble in focused ultrasound systems in any particular biological setting, it will be understood that other embodiments can take the place of those referred to.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

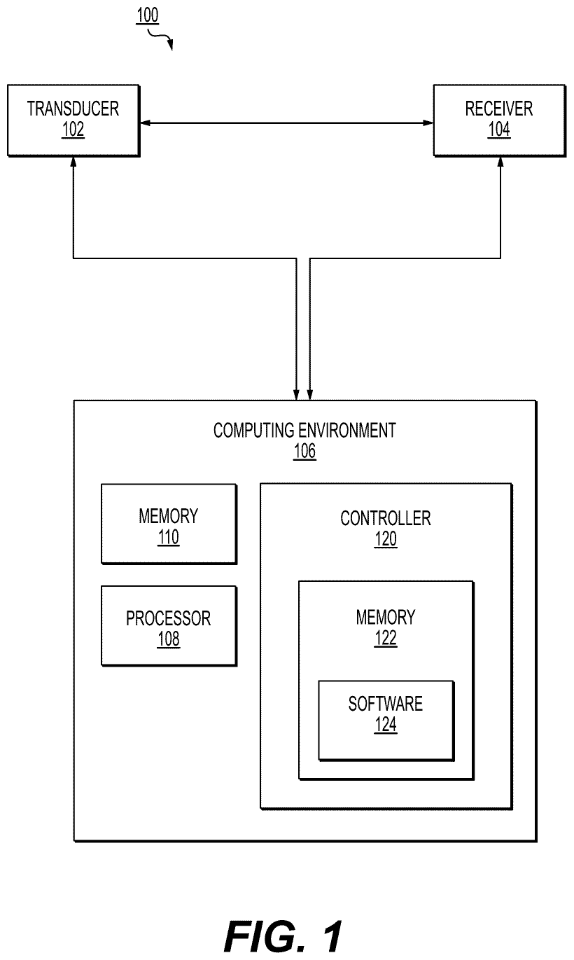

FIG. 1 illustrates an exemplary system 100 that may implement certain aspects of the present disclosure. The components and arrangements shown in FIG. 1 are not intended to limit the discloses embodiments as the components used to implement the disclosed processes and features may vary. As shown in FIG. 1, in some implementations the system 100 includes at least one transducer 102, at least one receiver 104, and/or at least one computing environment 106. The at least one computing environment 106 may include one or more processors 108, one or more transceivers, a user portal, and/or one or more controllers 120. In various embodiments, the one or more controllers 120 may be a separate component from the computing environment, such that, the one or more controllers 120 may comprise one or more processors, one or more memory modules, and/or be in communication with the at least one transducer 102, at least one receiver 104, and/or at least one computing environment 106.

In various embodiments, the at least one transducer 102 can be a device that produces sound waves across a surface and to a region of interest, the at least one receiver 106 (e.g., sensor) can receive the radio frequency (RF) signals of the ultrasound waves bouncing off of a scatterer within the region of interest. In some examples, the at least one transducer 102 and the at least one receiver 104 can be a single piece of equipment that both transmits ultrasound waves and receives RF signals.

As non-limiting examples, the computing environment 106 may be one or more of a personal computer, a smartphone, a laptop computer, a tablet, other personal computing device, or a combination thereof. The transducer 102 may be one or more of a linear array transducer, a curved array transducer, a phased array transducer, an endocavitary transducer, a 3D transducer, a 4D transducer, an intravascular ultrasound transducer, any other transducer capable of performing the desired function, or a combination thereof. The receiver 104 may be one or more of an analog receiver, a digital receiver, a beamforming receiver, a dynamic range receiver, a time-gain compensation receiver, a doppler receiver, a harmonic imaging receiver, any other transducer capable of performing the desired function, or a combination thereof. In various embodiments, the at least one transducer 102, at least one receiver 104, at least one computing environment 106, and/or at least one controller 120 may be configured to communicate over a network, such as a local area network (LAN), Wi-Fi, Bluetooth, or other type of network, with the at least one transceiver and/or computing environment and may be connected to an intranet or the Internet, among other things. In various embodiments, the at least one computing environments 106 and/or at least one controller 120 may include one or more physical or logical devices (e.g., servers) or drives and may be implemented as a single server or a bank of servers (e.g., in a “cloud”). In various embodiments, the system 100 may further comprise at least one server and/or at least one database (not depicted) configured to communicate with one or more components of the system 100.

In some examples, the computing environment 106 and/or controller 120 may comprise, for example, a cell phone, a smart phone, a tablet computer, a laptop computer, a desktop computer, a sever, or other electronic device. The computing environment 106 and/or controller 120 may be a single server, for example, or may be configured as a distributed, or “cloud,” computer system including multiple servers or computers that interoperate to perform one or more of the processes and functionalities associated with the disclosed embodiments. In some embodiments, the computing environment 106 and/or controller 120 may further include a peripheral interface, a transceiver, a mobile network interface in communication with processor 108, a bus configured to facilitate communication between the various components of the computing environment 106 and/or controller 120, and a power source configured to power one or more components of the computing environment 106 and/or controller 120.

In various embodiments, the computing environment 106 may include one or more of a processor 108, input/output (“I/O”) device, memory 110 containing an operating system (“OS”), program, controller 120, or a combination thereof. In various embodiments, the controller 120 may include its own memory 122 comprising software 124 (e.g., program code, programmed instruction, and/or the like) and/or its own processor to perform the function as described hereinafter. In other embodiments, the controller may use the memory 110 and/or processor of the computing environment 106 to perform the function as described hereinafter.

In various embodiments, the computing environment 106 may comprise one or more processors 108, geographic location sensor (“GLS”) for determining the geographic location of computing environment 106, display for displaying content such as text messages, items, and selectable buttons/icons/links, environmental data (“ED”) sensor for obtaining environmental data including audio and/or visual information, and/or user interface (“U/I”) device for receiving user input data, such as data representative of a click, a scroll, a tap, a press, or typing on an input device that can detect tactile inputs. User input data may also be non-tactile inputs that may be otherwise detected by ED sensor. For example, user input data may include auditory commands. In some embodiments, environmental data sensor may include a microphone, frequency sensor, and/or an image capture device, such as a digital camera.

Memory 110, 122 may include one or more memory devices that store data and instructions used to perform one or more features of the disclosed embodiments. Memory 110, 122 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational databases. Memory 110, 122 may include software components that, when executed by processor 110, perform one or more processes consistent with the disclosed embodiments. In some embodiments, memory 110, 122 may include a processing database and neural-network database for storing related data to enable the computing environment 106 and/or controller 120 to perform one or more of the processes and functionalities associated with the disclosed embodiments.

A peripheral interface may include the hardware, firmware, and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general-purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. The transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area network. In some embodiments, a mobile network interface may include hardware, firmware, and/or software that allows processor(s) 108 to communicate with other devices via wired or wireless networks, whether local or wide area, private or public, as known in the art. A power source may be configured to provide an appropriate alternating current (AC) or direct current (DC) to power components.

As described above, the computing environment 106 and/or controller 120 may be configured to remotely communicate with one or more other devices, such as at least one transducer 102, at least one receiver 104, at least one server, at least one database and/or other external devices.

Processor 108 may include one or more of a microprocessor, a microcontroller, a digital signal processor, a co-processor or the like or combinations thereof capable of executing stored instructions and operating upon stored data. Memory 110, 122 may include, in some implementations, one or more suitable types of memory (e.g. such as volatile or non-volatile memory, a random access memory (RAM), a read only memory (ROM), a programmable read-only memory (PROM), an erasable programmable read-only memory (EPROM), an electrically erasable programmable read-only memory (EEPROM), one or more magnetic disks, one or more optical disks, one or more floppy disks, one or more hard disks, one or more removable cartridges, a flash memory, a redundant array of independent disks (RAID), and the like), for storing files including an operating system, one or more application programs (including, for example, a web browser application, a widget or gadget engine, and or other applications, as necessary), executable instructions and data. In one embodiment, the processing techniques described herein are implemented as a combination of executable instructions and data within memory 110, 122.

Processor 108 may be one or more known processing devices, such as a microprocessor from the Pentium™ family manufactured by Intel™ or the Turion™ family manufactured by AMD™. Processor 108 may constitute a single core or multiple core processor that executes parallel processes simultaneously. Processor 108 may be a single core processor, for example, that is configured with virtual processing technologies. In certain embodiments, processor 108 may use logical processors to simultaneously execute and control multiple processes. Processor 108 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

The computing environment 106 and/or controller 120 may include one or more storage devices configured to store information used by processor 108 (or other components) to perform certain functions related to the disclosed embodiments. In one example, the computing environment 106 and/or controller 120 may include memory 110, 122 that includes instructions to enable processor 108 to execute the methods described hereinafter and/or one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the computing environment 106 and/or controller 120 may include memory 110, 122 that includes instructions that, when executed by processor 108, perform one or more processes consistent with the functionalities disclosed herein. Methods, systems, and articles of manufacture consistent with disclosed embodiments are not limited to separate programs or computers configured to perform dedicated tasks. The computing environment 106 and/or controller 120 may include memory 110, 122 including one or more software 124 (e.g., program), for example, to perform one or more functions of the disclosed embodiments. Moreover, processor 108 may execute one or more software 124 (e.g., program) located remotely from the environment 106 and/or controller 120. For example, the computing environment 106 and/or controller 120 may access one or more remote software 124 (e.g., program), that, when executed, perform functions related to disclosed embodiments.

The computing environment 106 and/or controller 120 may also be communicatively connected to one or more memory devices (e.g., databases (not shown)) locally or through a network. The remote memory devices may be configured to store information and may be accessed and/or managed by the computing environment 106 and/or controller 120. By way of example, the remote memory devices may be document management systems, Microsoft™ SQL database, SharePoint™ databases, Oracle™ databases, Sybase™ databases, or other relational databases. Systems and methods consistent with disclosed embodiments, however, are not limited to separate databases or even to the use of a database.

The computing environment 106 and/or controller 120 may also include one or more I/O devices that may include one or more interfaces (e.g., transceivers) for receiving signals or input from devices and providing signals or output to one or more devices that allow data to be received and/or transmitted by the computing environment 106 and/or controller 120. The computing environment 106 and/or controller 120 may include interface components, for example, which may provide interfaces to one or more input devices, such as one or more keyboards, mouse devices, touch screens, track pads, trackballs, scroll wheels, digital cameras, microphones, sensors, and the like, that enable the computing environment 106 and/or controller 120 to receive data from one or more users.

In example embodiments of the disclosed technology, the computing device may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the computing environment 106 and/or controller 120 has been described as one form for implementing the techniques described herein, those having ordinary skill in the art will appreciate that other, functionally equivalent techniques may be employed. As is known in the art, some or all of the functionality implemented via executable instructions may also be implemented using firmware and/or hardware devices such as, for example, application specific integrated circuits (ASICs), programmable logic arrays, state machines, etc. Furthermore, other implementations of the computing device may include a greater or lesser number of components than those illustrated.

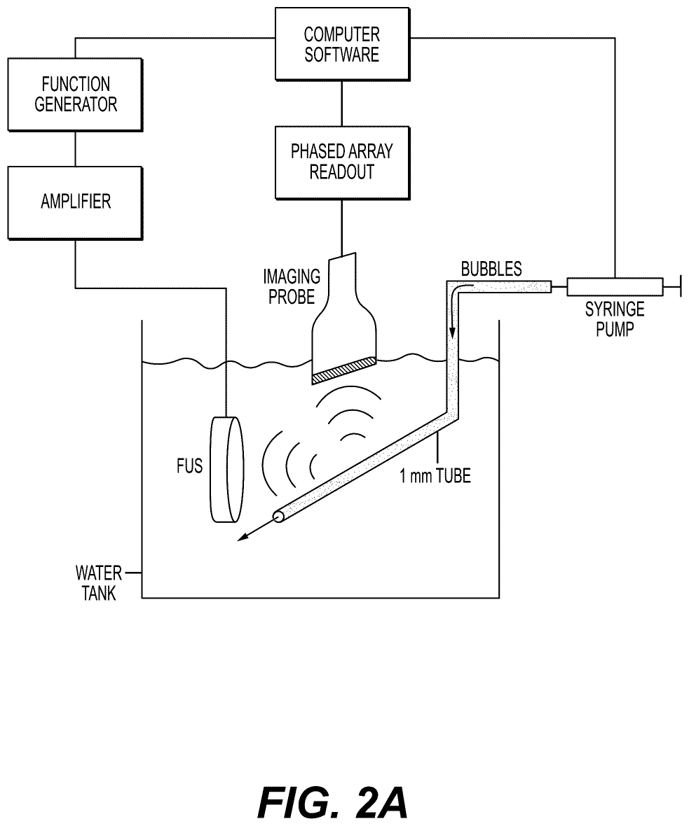

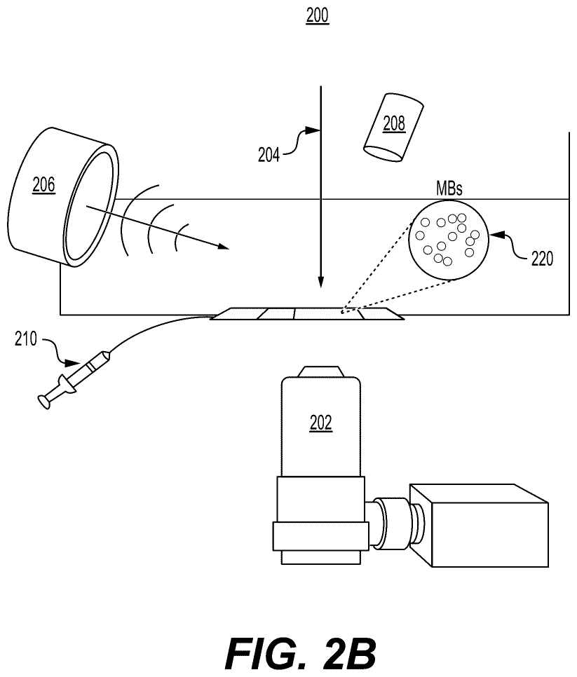

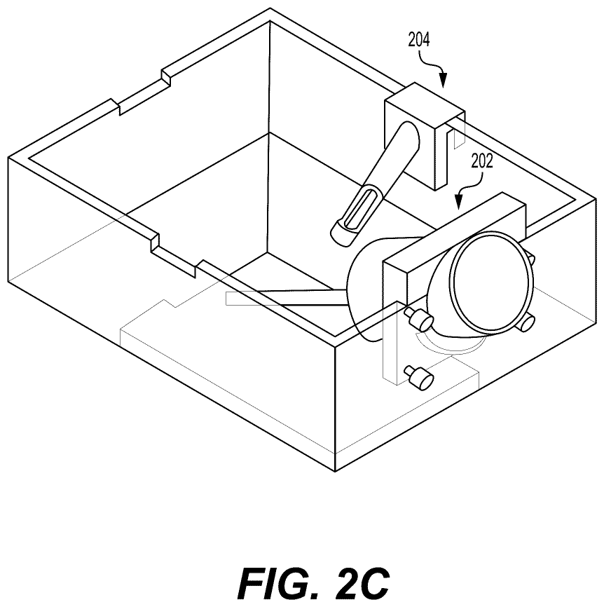

FIGS. 2A-2C illustrate exemplary experimental configuration of a system in accordance with various embodiments of the present disclosure. FIG. 2A illustrates an experimental setup was created to test the controllers described herein. An excitation waveform (sinusoidal excitation: 1.64 MHz; pulse duration: 10 ms; pulse repetition frequency: 1 Hz) was sent from a waveform generator for 120 seconds under concurrent intravenous (i.v.) administration of clinical grade microbubbles (100 μL/kg, Definity, Lantheus Medical Imaging). During the sonication, the receiver recorded/controlled the acoustic emission (AE) using the single element PCD (3.5 MHz center frequency). In an exemplary embodiment, at least one transducer (e.g., PCD transducer) used may have a sensitivity centred at 3.5 MHz. In one or more embodiment, to accurately calibrate the at least one transducer (e.g., PCD transducer), the at least one transducer may be cross calibrated in free field to a wideband hydrophone (2 mm model, Precision Acoustics) using a spherically propagating wave.

FIGS. 2B-2C illustrate exemplary configurations of a system to perform the function as described herein in accordance with various embodiments of the present disclosure. In various embodiments, as depicted in FIG. 2B, the system 200 may comprise at least one imaging device (e.g., optical imaging device, and/or the like), at least one light source 204, at least one transducer (e.g., similar to one describe with reference to FIG. 1), at least one receiver 208 (e.g., similar to one describe with reference to FIG. 1), and/or at least one microbubble (e.g., at least one oscillating microbubble).

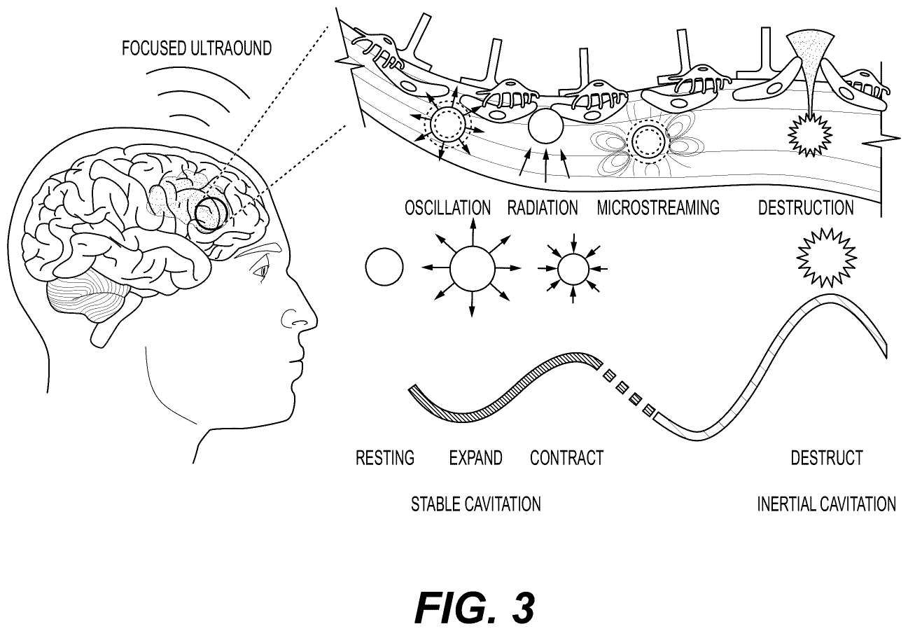

FIG. 3 illustrates an exemplary representation of microbubble focus ultrasound (MB-FUS) in accordance with various embodiments of the present disclosure. In various embodiments, the at least one transducer may transmit at least one propagation wave configured to cause at least one microbubble to oscillate. In various embodiments, a radius of at least one microbubble may expand and/or contract due to the at least one propagation wave (e.g., ultrasound wave). In various embodiments, the oscillation (e.g., expansion and/or contraction of the radius) of the at least one microbubble may cause an acoustic emission (AE). In various embodiments, the at least one receiver of the system may be configured to receive the AE from the at least one oscillating microbubble. In one or more embodiments, the system may use a controller comprising an algorithm to convert the AE data to determine at least one acoustic emission frequency of the at least one microbubble, such that the algorithm may use the at least one acoustic emission frequency a to determine at least one dynamic property of the at least one microbubble. In various embodiments, the at least one dynamic property of the at least one microbubble is one or more of a change, with respect to time, of a radius, pressure, phase, frequency, amplitude, or a combination thereof.

### Example 1. Linear Acoustic Wave Propagation and Superposition

In various embodiments, a linear mathematical and/or acoustical estimation method can be used to decouple highly nonlinear microbubble oscillation and/or acoustic emission into one or more linear component. In various embodiments, the one or more linear components may be used for computation of at least one AE generated from at least one microbubble. The advantage of linearizing (i.e., decoupling) MB oscillation is that the forward process (Estimating AE from MB oscillation) can be reversed for a reconstruction (Estimating MB oscillation radius from AE).

At low excitation pressures, at least one oscillating microbubble (e.g., at least one microbubble (MB)) may be regarded as an acoustic monopole (i.e., a point source radiating sound uniformly in all directions). For a simple harmonic (i.e., single angular frequency ω) oscillating monopole at its steady (e.g., periodic) state, as depicted in Equation 1, there may exist a simple solution to the pressure field computed with Euler's equation, which relates the particle velocity of surrounding fluid to the pressure, depicted in Equation 2.

$$\dot{R} = \vert \dot{R} \vert {e}^{j ω t} \qquad Equation 1$$

Applying the following boundary condition, the particle velocity of fluid in contact with source is equal to source's surface velocity, the Euler's equation becomes:

$$\dot{R} = - \frac{1}{{ρ}_{0}} \int \overline{V} {P}_{( r , t )} dt \qquad Equation 2$$

Considering the spherical wave equation, depicted in Equation 3, and combining it with Equation 2 with a boundary condition (equal velocity at r=R₀), a general solution for pressure at any far field distance r, as in Equation 4.

$${P}_{( r , t )} = \frac{A}{r} * {e}^{j ( ω t - kr )} \qquad Equation 3$$

$${P}_{( r , t )} = \frac{{ρ}_{0} * ω * {R}_{0}^{2}}{r} * {( k {R}_{0} - j )}^{- 1} * {e}^{- jk ( r - {R}_{0} )} * \dot{R} \qquad Equation 4$$

In most cases of interest the MBs' dynamics are non-linear and contain multiple frequency. The solution to the Euler's Equation in this case is not trivial. However, by assuming that i) MBs' oscillations are purely spherical and/or ii) MBs' oscillations contain frequency content that are multiples (e.g., “n”, real number) of fundamental angular frequency (ω, or 2πf₀), individual oscillations can be isolated by their frequency using Fourier Series Expansion, as depicted in Equation 5.

$$\dot{R} = {\sum }_{n = 1}^{∞} \vert \dot{{R}_{n}} \vert * {e}^{nj ω t} \qquad Equation 5$$

Similarly, the resulting pressure field can also be isolated with single frequency components using Fourier Expansion, as shown in Equation 6.

$${P}_{( r , t )} = {\sum }_{n = 1}^{∞} \vert {P}_{n} \vert * {e}^{nj ω t} \qquad Equation 6$$

Applying the linearized expressions onto Euler's Equation gives Equation 7.

$$Equation 7$$

$${P}_{( r , t )} = {\sum }_{n = 1}^{∞} \vert {P}_{n} \vert * {e}^{nj , ω t} = {\sum }_{n = 1}^{∞} \frac{{ρ}_{0} ω {R}_{0}^{2}}{r} * {( {kR}_{0} - \frac{j}{n} )}^{- 1} * {e}^{- njk ( r - {R}_{0} )} * \dot{{R}_{n}}$$

Assuming that each frequency content of surface velocity only affects the same frequency content in pressure, Equation 7 can be simplified to an element-to-element basis, to Equation 8, thus providing the potential to propagate a pressure field from a single MB.

$${P}_{n ( r , t )} = \frac{{ρ}_{0} ω {R}_{0}^{2}}{r} * {( {kR}_{0} - \frac{j}{n} )}^{- 1} * {e}^{- njk ( r - {R}_{0} )} * \dot{{R}_{n}} \qquad Equation 8$$

Since the propagation is linear one can reconstruct the surface velocity (\dot{R}) from pressure (P_{(r,t)}) by inversing Equation 8 and summing all its frequency contents, as shown in Equation 9.

$$\dot{R} = {\sum }_{n = 1}^{∞} \frac{r}{{ρ}_{0} ω {R}_{0}^{2}} * ( {kR}_{0} - \frac{j}{n} ) * {e}^{njk ( r - {R}_{0} )} * {P}_{n} \qquad Equation 9$$

The radius as function of time (i.e., R₍ₜ₎), which is the information of interest, can be obtained by integrating the obtained surface velocity, as shown in Equation 10.

$${R}_{( t )} = \int \dot{R} dt \qquad Equation 10$$

Here, as a result, a Linear Acoustic Wave Propagation and Superposition (LAWPS) algorithm (e.g., algorithm) has been derived to analytically propagate and/or backpropagate the surface velocity to pressure and/or pressure to surface velocity.

### Example 2. Generating a Single Microbubble Using Rayleigh-Plasset Equation

The Rayleigh-Plesset (RP) equation may be used to generate a single microbubble source to apply LAWPS algorithm (e.g., algorithm). RP equation may be configured to describe the response of a spherical bubble (e.g., microbubble, oscillating microbubble, and/or the like) to a time-varying pressure field in an incompressible fluid, using energy balance, as shown in Equation 11.

$${ρ}_{0} ( R \ddot{R} + \frac{3}{2} {\dot{R}}^{2} ) = ( {P}_{0} + \frac{2 σ}{{R}_{0}} ) {( \frac{{R}_{0}}{E} )}^{3 k} - \frac{2 σ}{R} - 4 μ \frac{\dot{R}}{R} - {P}_{0} + {P}_{ac ( t )} \qquad Equation 11$$

In an exemplary embodiment, R is the bubble radius (unknown), R₀ is initial radius (depending on MB size), ρ₀ is density of surrounding fluid (998 kg/m³), P₀ is ambient pressure (100 kPa), κ is polytropic gas constant (1.4), μ is fluid viscosity (0.001 Pa·s), and P_{ac} is transient acoustic pressure as function of time (30 kPa, with 0.5 MHz). Pᵥ is vapor pressure (2330 Pa), σ is surface tension (0.072 N/m). For the specific steady state purpose, the generated microbubble may be oscillated with a sinusoid pressure (e.g., P_{ac (t)}=A sin ωt). In other embodiments, the LAWPS algorithm (e.g., algorithm) can be applied to any other MB models that incorporates shell & gas properties. RP model is used here for a simple example.

### Example 3. Propagation & Backpropagation of Pressure and Radius in Frequency Domain

To propagate the pressure from a single bubble source, a single Rayleigh microbubble may be generated from RP equation (Equation 11) using numerical methods to obtain R(t). In various embodiments, the LAWPS algorithm may be applied to the generated microbubble in a frequency domain. To convert to frequency domain, analytical Fourier transformation may be applied onto propagation method (Equation 7) and backpropagation method (Equation 9), which becomes Equation 12 and Equation 13, respectively in frequency domain.

$${P}_{( r , ω )} = {\sum }_{n = 1}^{∞} \frac{{ρ}_{0} ω {R}_{0}^{2}}{r} * {( {kR}_{0} - \frac{j}{n} )}^{- 1} * {e}^{- njk ( r - {R}_{0} )} * {\int }_{- ∞}^{∞} {\dot{R}}_{n} {e}^{- j ω t} dt \qquad Equation 12$$

$${\dot{R}}_{( ω )} = {\sum }_{n = 1}^{∞} \frac{r}{{ρ}_{0} ω {R}_{0}^{2}} * ( {kR}_{0} - \frac{j}{n} ) * {e}^{njk ( r - {R}_{0} )} * {\int }_{- ∞}^{∞} {P}_{n} {e}^{- j ω t} dt \qquad Equation 13$$

Here, the integral terms at the right-hand side is essentially the frequency spectrum of surface velocity or pressure. In one or more embodiments, the derivative in frequency domain, in Equation 14, may be used to differentiate R to get surface velocity. In one or more embodiment, an inverse Fourier transform is applied on result from Equation 14 for a solution.

$${\dot{R}}_{( ω )} = j 2 π {fR}_{( ω )} \qquad Equation 14$$

Although computation in frequency domain is convenient, spectral leakages occur due to discrete sampling. To mitigate for this, a band width (fₙ±15 kHz) may be set for each of the frequency where the LAWPS algorithm is applied.

### Example 4. Inverse LAWPS (Acoustic Emission (AE) to Radius Determination)

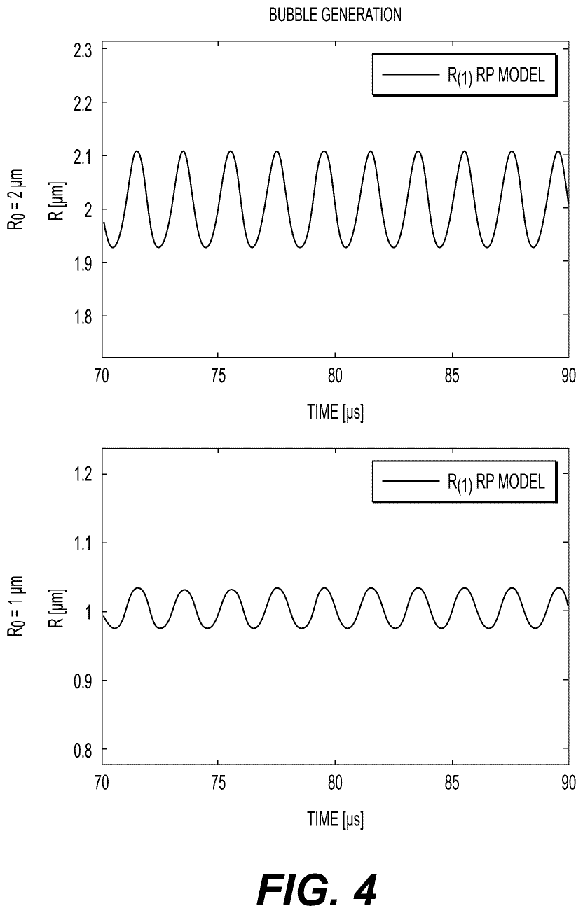

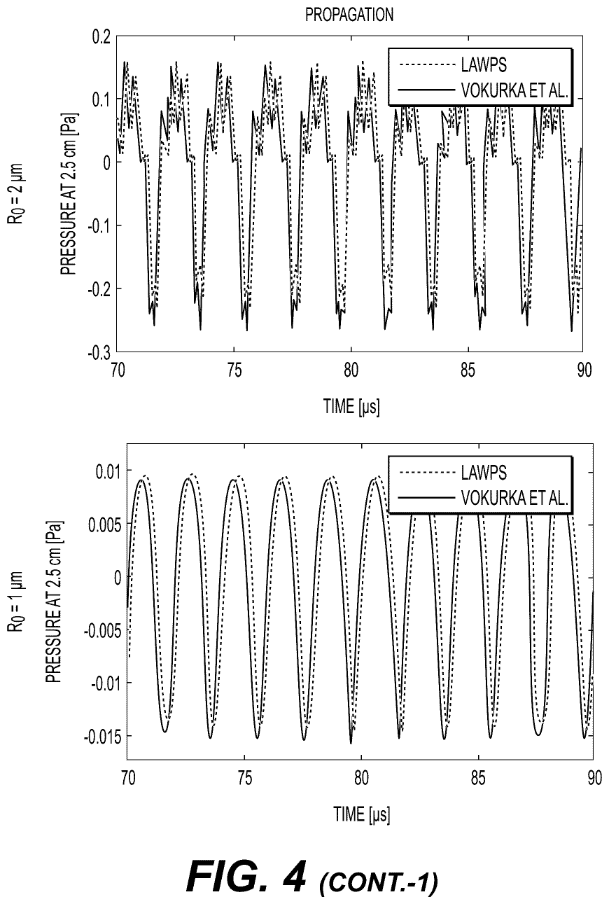

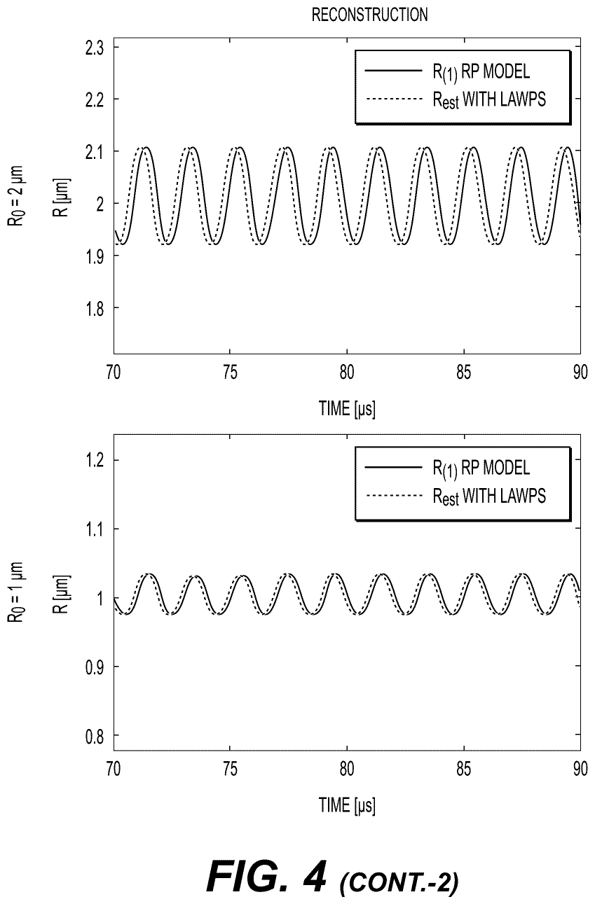

The advantage of a linear algorithm is that the entire propagation framework can be linearly reversed for a reconstruction (e.g., determining at least one oscillating microbubble radius and/or an average pressure of at least one microbubble). To further confirm our approach, the inverse LAWPS algorithm may be employed onto the pressure estimated by literature to determine original RP bubble's radius change. As depicted in FIG. 4, the determination may reproduce at least one original microbubble model with less than 1% error of peak-to-peak radius change, suggesting that incorporated methods are indeed linear and reversible. In aggregate, the determination demonstrated the potential of LAWPS algorithm to be applied to acoustic emissions data recorded in in vivo conditions. Importantly, since LAWPS algorithm is independent of MB properties, acoustic emission(s) (AE) can be used to reconstruct MB oscillation radius, which can be used for, for example, estimating multiple properties of MB (e.g., dynamic properties of at least one microbubble).

With reference to FIG. 4, at least one microbubble may be generated from Rayleigh-Plesset equation (Equation 11). The pressure propagation depicts LAWPS algorithm (0.41 Pa) and Vokurka's Algorithm (0.42 Pa) for different initial radius. The reconstruction (e.g., determination) of at least one MB dynamics (i.e., initial model) using inverse LAWPS algorithm. FIG. 4 illustrates the reconstruction (e.g., determination) error was in amplitude was less than 0.5%.

### Example 5. In Vitro Application of LAWPS Algorithm

To test the ability of LAWPS algorithm to reconstruct MB radius in in vitro settings, a microfluidic system under high frame rate microscopy was used to compare the reconstruction with optical observations (e.g., an example system in FIG. 2C) on Definity MBs. However, extending the proposed LAWPS algorithm to in vitro setup introduces various and important challenges. Since the derivation is based on a single MB scheme with single initial radius (R₀) value, for a practical application of LAWPS algorithm for multiple MBs, there is necessity to incorporate a method to accommodate for multiple MB and multiple size (i.e., polydisperse) scheme. Moreover, AE from multiple MBs can propagate with constructive and/or destructive manner in time such that measurement from a single receiver may not purely represent each individual MB's dynamics. There could also be uncertainties introduced from i) non-uniform sensitivity of PCD, ii) reflections of the excitation pressure (i.e., signals that are not from MBs' oscillation). While the latter can be accommodated with precise calibration of PCD and measuring background AE signals (without MBs) to isolate MB signals, translating LAWPS algorithm to multiple MB scheme holds the utmost importance and challenge.

In various embodiments, the PCD may record the signal from multiple microbubbles. Thus, the signal strength is not only dependent on MB dynamics strength, but also the number of MBs in the focal region. In an example embodiment, an estimated number of microbubbles in the focal region was determined by counting the MBs in the optical microscopy. For in vivo study, the number of estimate microbubbles was determined by using vascular density, as shown in Equation 15.

$$\# MB in focal = ( \frac{\# MB injected}{{totalV}_{blood}} ) ( {V}_{focal} \frac{{V}_{blood} in brain}{{V}_{brain}} ) \qquad Equation 15$$

In an example embodiment, 1.44×10⁷ MBs were injected into the mouse body, which had total blood volume 1.925 ml and brain blood volume of 46 μl. It was assumed that the microbubbles were uniformly distributed throughout body, giving us approximately 3300 MBs in the brain focal region.

### Example 5.1. In Vitro Application of LAWPS Algorithm for Multiple Microbubble Scheme

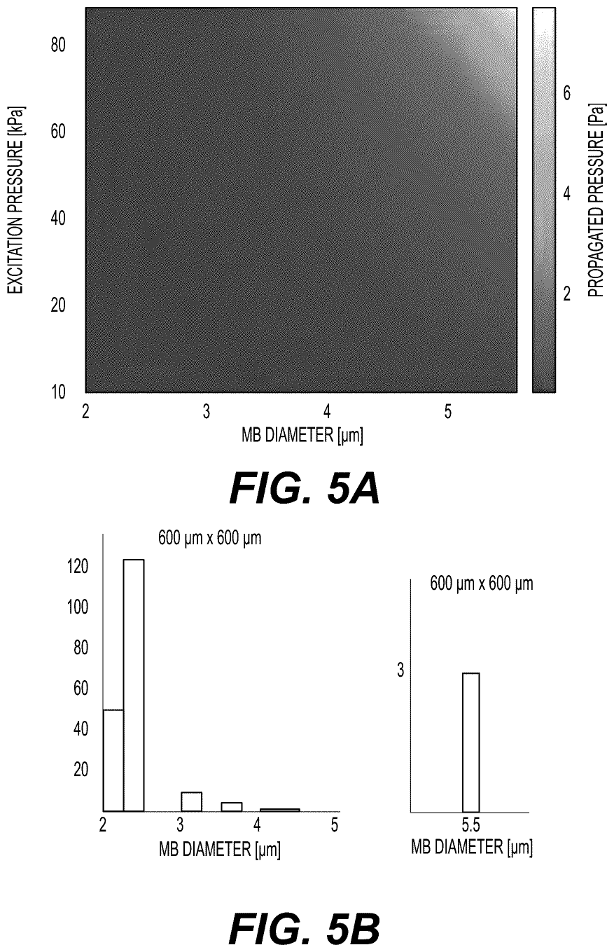

As a method to address the challenge coming from multiple MBs under microscopy, optical imaging was used to estimate the total number and size distribution of MBs under microfluidic channel. Using this information and mathematical MB with a shell model, an estimation of each MBs “efficiency” was calculated” in generating AE, depicted in FIGS. 5A-5B. FIG. 5A, in various embodiments, graphically illustrates a monodisperse distribution estimation, such that the AE “efficiency” for different size MBs and excitation pressure were estimated. The AE may be generated using Hoff & Church MB shell model combined with Vokurka's RP based pressure estimation. FIG. 5B, in various embodiments, graphically illustrates the observed optical measurement of microbubble size distribution (left) and monodisperse microbubble size distribution that generates AE as polydisperse distribution (right). This information may be used to convert the polydisperse size distribution to a monodisperse size distribution. Due to this reason, using monodisperse (i.e., uniform size distribution) MBs will significantly augment the algorithm, as there will be less assumptions involved and is more trivial.

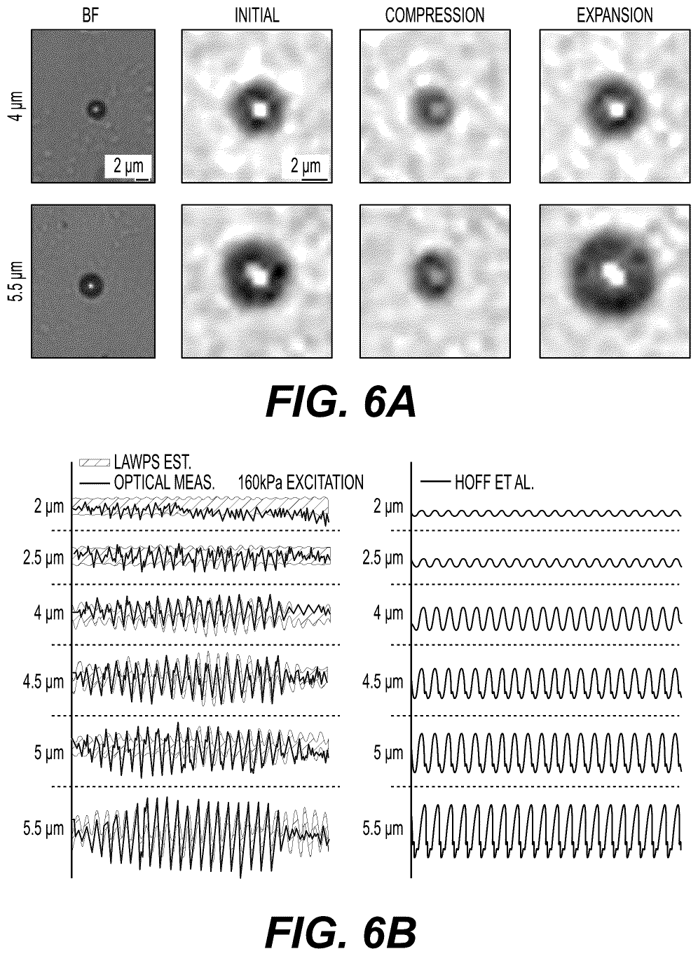

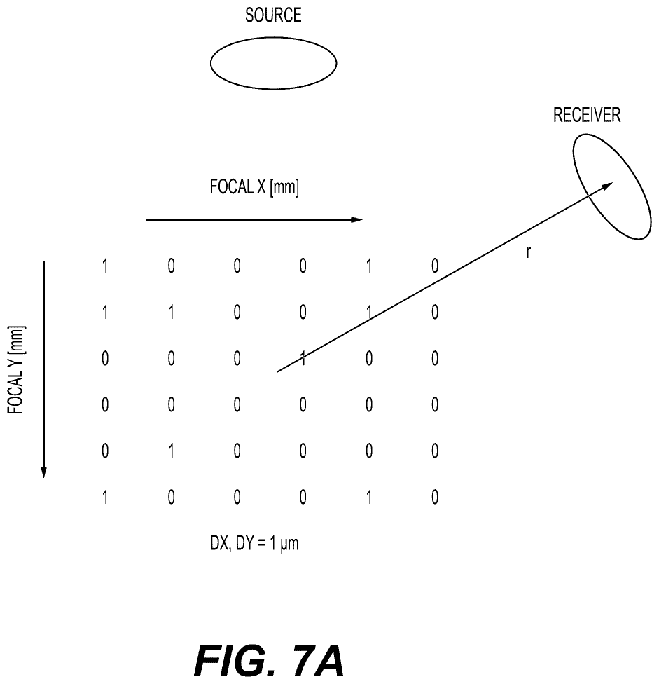

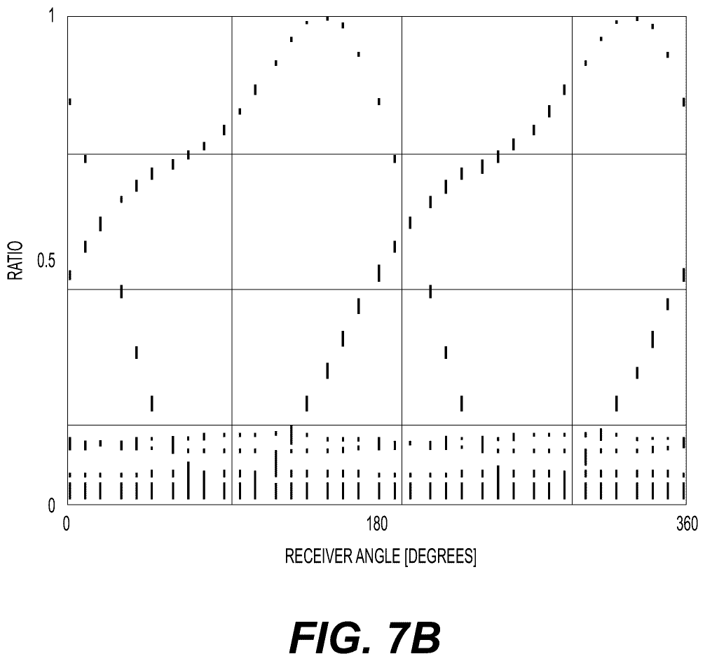

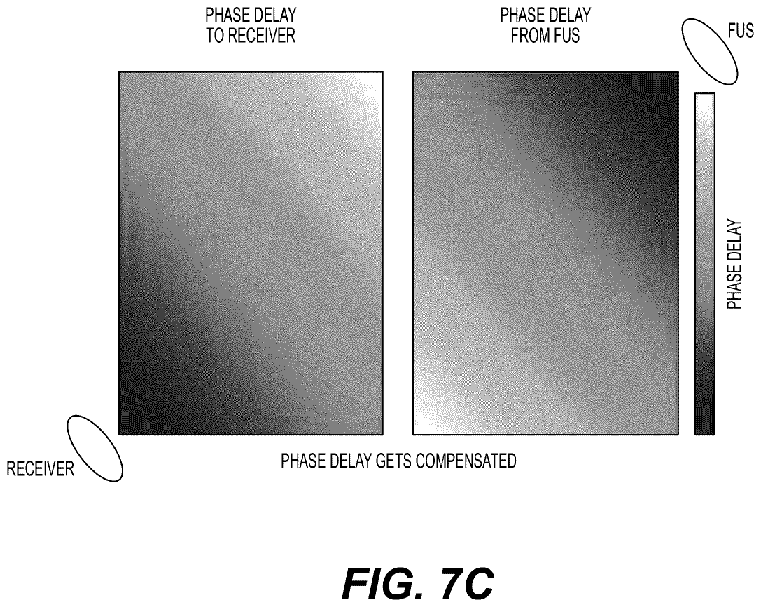

Assuming purely constructive interference from multiple MBs, the monodisperse estimation may be used onto LAWPS algorithm to reconstruct MB dynamics from MB AE with 89.9% accuracy within the maximum interval of LAWPS reconstruction with uncertainty (0.25 μm due to microscopy resolution) interval, as illustrated in FIG. 7A. FIGS. 6A-6B illustrates the feasibility of LAWPS algorithm and suggests that with accurate assumptions and information of the MB size distribution, LAWPS algorithm can closely agree with the true MB dynamics.

In various embodiments, the measurements from PCD transducer used for determining the reconstruction of MB dynamics not only possess the MB AE, but also the reflected signal from skull (in vivo) or microfluidic device (in vitro). To isolate MBs' signal from the reflected waves, the background signal(s) may be measured without MBs, then subtracted the background signal from the signal with MB. MBs' signals are subject to attenuation when they propagate through the skull. To correct for attenuation during in vivo study, a transmission coefficient may be calculated for normal incidence of different frequency (i.e., harmonic signals) ultrasound onto 100 μm thickness skull with speed of sound 4080 m/s and density 1658 g/cm³.

In various embodiments, FIGS. 6A-6B graphically illustrates exemplary results from in vitro application of the LAWPS algorithm (e.g., algorithm). As depicted in FIG. 6A, optical images illustrate oscillation of at least one microbubble. FIG. 6B illustrates, in various embodiments, at least one optical measurement of MBs (polydisperse Definity MBs, diameter shown on left) in focal region using high framerate microscopy compared to LAWPS reconstruction. FIG. 6B further illustrates MB radius dynamics estimation using literature method with shell (right). Optical measurement and LAWPS reconstruction agrees with model in a way where increasing MB size results in increasing strength in MB dynamics.

### Example 5.2. Possible Acoustical-Simulation Modality to Accommodate for Microbubble Distribution

Although the LAWPS algorithm resulted in fair accuracy in reconstruction of MB radius dynamics, it was under an important assumption that AE from multiple MBs were purely constructive. However, depending on the spatial location and distribution of each MBs, even a small (order of m) difference in distance can result in a significant phase delay of AE and thus significantly destructive AE behavior, causing loss of AE and thus inaccurate LAWPS reconstruction. Hence, in order for LAWPS to be a more robust algorithm in reconstructing MB dynamics, there is a necessity to investigate the effect of the spatial MB distribution in the FUS focal region on the propagated AE.

FIG. 7A illustrates, in various embodiments, a schematic illustration of a monodisperse MB spatial distribution. In various embodiments, an exemplary schematic may indicate the location of at least one microbubble with “1”. To identify the effect of spatial MB distribution on the recorded AE, a randomly distributed monodisperse was simulated, such that MBs emitted a single frequency and pressure using Poisson-disc sampling. Further, the AE was delivered to a receiver with varying 3-dimensional location (0-360 degrees rotation in space) when excited with FUS excitation whose location also varied 3-dimensionally (0-360 degrees rotation in space). At each angle and parameter, 1000 random MB distribution were generated to simulate propagated AE. The idea here is to identify the two types of phase delays coming from MB spatial distribution: i) phase delay due to propagation of source (in FIG. 7A, bottom MBs will start oscillating at a later time point compared to the top), and ii) phase delay due to propagation of AE (AE from the MBs that are closer to the receiver will arrive faster than others).

As a result of the random MB distribution simulation, the simulation illustrated a clear trend (multi-dimensional function) between the destructive/constructive AE interference and angle of receiver, azimuth of receiver, angle of source, azimuth of source, number of MBs distributed in the area, and size of MBs. Meanwhile, the distribution of such trends was close to Gaussian distribution, suggesting the feasibility of machine learning algorithm such as Kernel Ridge Regression model.

Importantly, apart from the machine learning feasibility, the simulation at different source and receiver angles suggested an ideal position where purely constructive interference is present, as illustrated in FIG. 7B. This ideal position is when FUS source and receiver are at the opposite location (180 degrees) where the phase delays from source propagation and AE propagation mitigates for each other that results in purely constructive interference. This has potential to be a critical finding since current passive cavitation detection technologies incorporates source and receiver to be coaxially aligned (0 degrees), and no such investigations exists on sensitivity effect of source/receiver position. Furthermore, this geometry (source & receiver being placed at 180 degrees, facing each other) can be utilized to enhance the sensitivity of transcranial (through skull) cavitation detection methods, which is considered as challenging problem due to the skull attenuation, as illustrated in FIGS. 7B-7C. FIG. 7B graphically illustrates the destructive interference as a function of a receiver angle (1 indicate purely constructive interference). FIG. 7C illustrates an exemplary positioning of an ideal location receiver and source for purely constructive interference of AE (180 degrees).

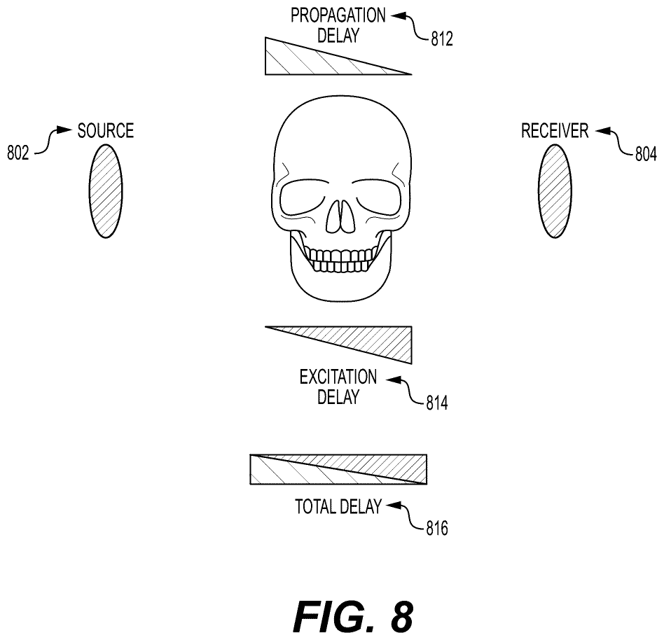

FIG. 8 illustrates an exemplary transcranial application of positioning the at least one transducer and at least one receiver in accordance with various embodiments of the present disclosure. In various embodiments, the system 800 may position the at least one transducer 802 at an ideal position relative to the at least one receiver 804. In various embodiments, the at least one transducer 802 may be located at a position 180 degrees relative to the at least one receiver 804. In various embodiments, the at least one transducer 802 may be located at a position relative to the at least one receiver 804, such that there is only pure constructive interference. In various embodiments, the system 800 may determine propagation delay 812 and excitation delay 814 to determine the total delay 816.

### Example 6. In Vivo Application of LAWPS Algorithm

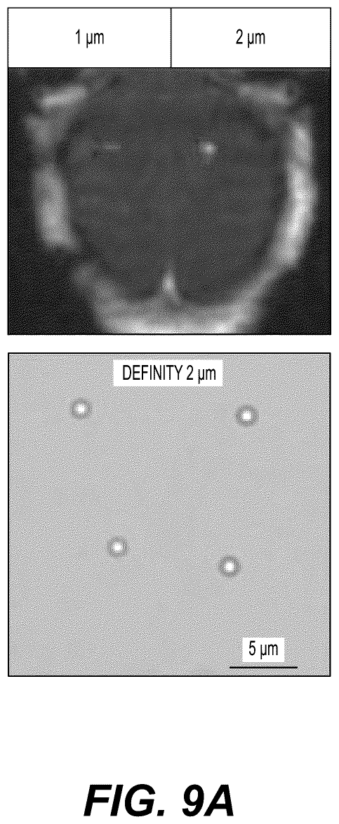

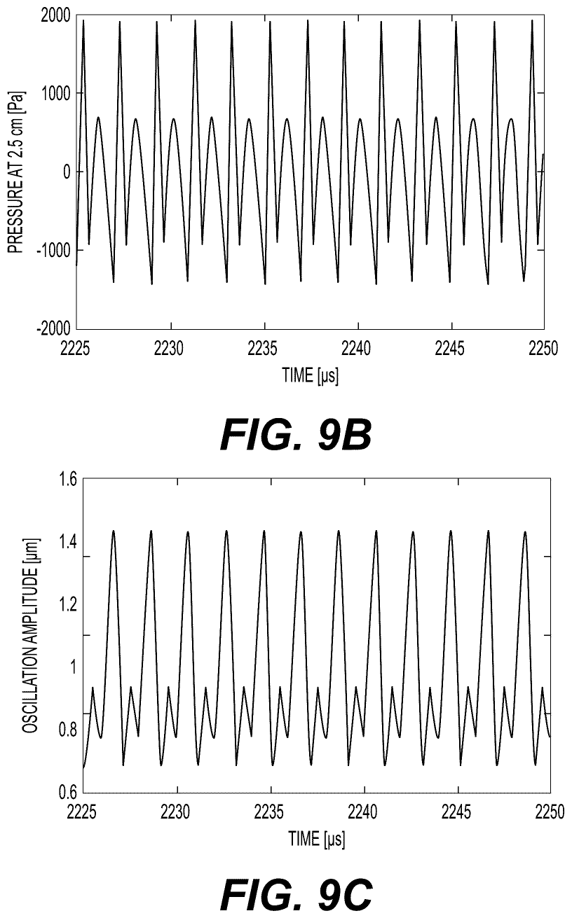

To further test the LAWPS algorithm in reconstructing MB dynamics, in vivo experiments were conducted in healthy mice brain. In addition to the uncertainties introduced in in vitro setup, in vivo environment introduces i) attenuation due to skull, ii) phase shift from filters, iii) number of MBs in focus, and iv) MB to vessel interactions. To minimize the uncertainty in reconstruction related to MB size, in this study, a monodispersed MBs was used (Definity, 2 μm, as shown in FIG. 9A). FIGS. 9B-9C graphically illustrate the recorded pressure from 2 μm diameter Definity MBs and the Reconstructed MB radius dynamics using inverse LAWPS algorithm with initial radius 1 μm (=2 μm diameter), respectively. Additionally, to mitigate the above uncertainties, the experiment i) estimated a plane wave's attenuation through skull to correct the recorded pressure, ii) corrected phase delays according to filter specifications, and iii) incorporated a vascular density map to estimate the number of MBs in focal region in the brain. As a result of applying LAWPS algorithm in in vivo conditions (at timepoints immediately after MB arrival), the experiment was to capture different MB behaviours (e.g., expansion or compression only changes in MB radius, as illustrated in FIGS. 9B-9C). The experiment illustrates that the estimated number of MB in the focal region using vascular density is plausible in reconstructing the stable MB dynamics regime.

### Example 7. Exemplary Controller Employing the Present Methods

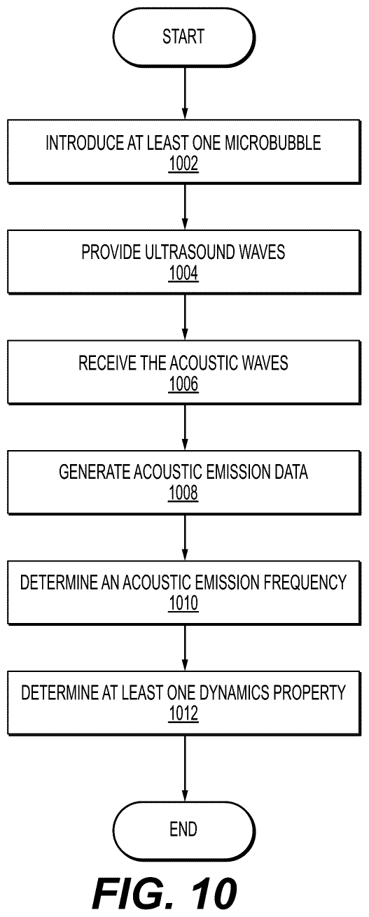

FIG. 10 illustrates a flow diagram of an exemplary method 1000 for determining the dynamics of at least one microbubble in accordance with various embodiments of the present disclosure. The steps of method 1000 may be performed by one or more components of the system, computing environment, and/or controller, as described in more detail with respect to FIGS. 1-2C.

Method 1000 may begin with the system and/or controller, such that the system and/or controller comprises an algorithm (e.g., LAWPS algorithm) that is independent from one or more properties of the at least one microbubble, may introduce at least one microbubble into a vessel, Block 1002. In various embodiments, the at least one microbubble may be introduced into the vessel with at least one injection device. In various embodiments, the at least one transducer (e.g., waveform generator) and the at least one receiver may be positioned opposite of each other, such that the position of the at least one transducer and the at least one receiver may result in constructive propagation and/or backpropagation from the at least one microbubble. In various embodiments, the system and/or controller may be further configured to identify one or more types of phase delays. In various embodiments, the one or more phase delays may be due to one or more of spatial distribution of the at least one microbubble, a propagation source, propagation of the acoustic emission data, or a combination thereof.

In Block 1004, the system and/or controller is configured to provide at least one ultrasound wave through an outer surface of the vessel and to at least a portion of the at least one microbubble. In various embodiments, the at least one ultrasound wave may cause the at least one microbubble to oscillate. In one or more embodiments, a frequency at which the at least one microbubble oscillates is dependent on one or more of a microbubble size, gas properties of a microbubble, surrounding fluid, transmitted frequency from the waveform generator, or a combination thereof. In one or more embodiments, the at least one microbubble may comprise an oscillation motion that is one or more of a linear oscillation, nonlinear oscillation, or a combination thereof, wherein the oscillation of the at least one microbubble causes a change in the radius of the at least one microbubble. In various embodiments, the oscillation of the microbubble may cause the at least one microbubble to emit at least one acoustic wave. In various embodiments, at least one transducer of the system may transmit the at least one ultrasound wave.

In Block 1006, in various embodiments, the system and/or controller may be configured to receive, via at least one receiver, at least one acoustic waves. In various embodiments, the at least one received acoustic waves may comprise a first set of the acoustic waves during a first period of time and a second set of acoustic waves during a second period of time.

In Block 1008, in various embodiments, the system and/or controller may be configured to generate acoustic emission data based at least in part on the at least one acoustic waves (e.g., at least one received acoustic wave). In various embodiments, the system and/or controller (e.g., programmed instructions) may be configured to convert at least a portion of the acoustic emission data to a frequency domain. In one or more embodiments, the system and/or controller (e.g., programmed instructions) may be configured to determine, based at least in part on the acoustic emission data in the frequency domain, a pressure propagation of the at least one oscillating microbubble.

In Block 1010, in various embodiments, the system and/or controller (e.g., programmed instructions) may be configured to determine, based at least in part on the acoustic emission data, an acoustic emission frequency of the at least one microbubble.

In Block 1012, in various embodiments, the system and/or controller (e.g., programmed instructions) may be configured to determine, based at least in part on the acoustic emission frequency, at least one dynamic property of the at least one microbubble. In various embodiments, the at least one dynamic property of the at least one microbubble is one or more of a change, with respect to time, of a radius, pressure, phase, frequency, amplitude, or a combination thereof. In various embodiments, the system and/or controller (e.g., programmed instructions) may be configured to determine, based at least in part on the pressure propagation, at least one oscillating microbubble radius change. In various embodiments, the system and/or controller (e.g., programmed instructions) may be configured to determine, based at least in part on a determination of the radius change of at least one oscillating microbubble, the at least one dynamic property of the at least one microbubble.

In this description, numerous specific details have been set forth. It is to be understood, however, that implementations of the disclosed technology can be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described can include a particular feature, structure, or characteristic, but not every implementation necessarily includes the particular feature, structure, or characteristic. Further, repeated use of the phrase “in one implementation” does not necessarily refer to the same implementation, although it can.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner. By “comprising” or “containing” or “including” is meant that at least the named element, or method step is present in article or method, but does not exclude the presence of other elements or method steps, even if the other such elements or method steps have the same function as what is named.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for determining microbubble dynamics, the method comprising:
introducing at least one microbubble into a vessel;
providing ultrasound waves through an outer surface of the vessel and to at least a portion of the at least one microbubble, wherein the ultrasound waves cause the at least one microbubble to oscillate and emit acoustic waves;
receiving, via at least one receiver, the acoustic waves;
generating acoustic emission data based on the acoustic waves;
determining, based at least in part on the acoustic emission data, an acoustic emission frequency of the at least one microbubble; and
determining, based at least in part on the acoustic emission frequency, at least one dynamic property of the at least one microbubble, wherein the at least one dynamic property of the at least one microbubble is one or more of a change, with respect to time, of a radius, pressure, phase, frequency, amplitude, or a combination thereof.

2. The method of claim 1, wherein a frequency at which the at least one microbubble oscillates is dependent on one or more of a microbubble size, gas properties of a microbubble, surrounding fluid, transmitted frequency from the waveform generator, or a combination thereof.

3. The method of claim 1, wherein the received acoustic waves comprise a first set of the acoustic waves during a first period of time and a second set of acoustic waves during a second period of time.

4. The method of claim 1, wherein determining at least one dynamic property of the at least one microbubble comprises implementing an algorithm that is independent from properties of the at least one microbubble.

5. The method of claim 4, wherein the oscillation of the at least one microbubble is one or more of linear oscillation, nonlinear oscillation, or a combination thereof, wherein the oscillation of the at least one microbubble causes a change in the radius of the at least one microbubble.

6. The method of claim 5, wherein determining at least one dynamic property of the at least one microbubble comprises:
converting at least a portion of the acoustic emission data to a frequency domain;
determining, based at least in part on the acoustic emission data in the frequency domain, a pressure propagation of the at least one oscillating microbubble; and
determining, based at least in part on the pressure propagation, at least one oscillating microbubble radius change.

7. The method of claim 5, wherein determining at least one dynamic property of the at least one microbubble comprises:
determining, based at least in part on the at least one oscillating microbubble radius change, an average pressure for at least one microbubble.

8. The method of claim 7, the method further comprising:
determining, based at least in part on a determination of the radius change of at least one oscillating microbubble, the at least one dynamic property of the at least one microbubble.

9. The method of claim 1, the method further comprising:
identifying one or more type of phase delay due to a spatial distribution of the at least one microbubble, wherein the one or more type of phase delay is due to one or more of a propagation source, propagation of the acoustic emission data, or a combination thereof.

10. The method of claim 1, the method further comprising:
positioning the waveform generator and at least one receiver opposite of each other, wherein a position of the waveform generator and the at least one receiver results in constructive propagation from the at least one microbubble.

11. A system for determining microbubble dynamics, the system comprising:
a transducer configured to provide ultrasound waves and cause at least one microbubble to oscillate;
a receiver configured to receive signals produced by the ultrasound waves interacting with microbubbles;
a processing platform comprising at least one processor, the processing platform in communication with the transducer and the receiver; and
a controller in communication with the processing platform comprising at least one memory modules storing programmed instructions thereon that, when executed by the controller, cause the system to:
introduce at least one microbubble into a vessel;
provide ultrasound waves through an outer surface of the vessel and to at least a portion of the at least one microbubble, wherein the ultrasound waves cause the at least one microbubble to oscillate and emit acoustic waves;
receive, via at least one receiver, the acoustic waves;
generate acoustic emission data based on the acoustic waves;
determine, based at least in part on the acoustic emission data, an acoustic emission frequency of the at least one microbubble; and
determine, based at least in part on the acoustic emission frequency, at least one dynamic property of the at least one microbubble, wherein the at least one dynamic property of the at least one microbubble is one or more of a change, with respect to time, of a radius, pressure, phase, frequency, amplitude, or a combination thereof.

12. The system of claim 11, wherein a frequency at which the at least one microbubble oscillates is dependent on one or more of a microbubble size, gas properties of a microbubble, surrounding fluid, transmitted frequency from the waveform generator, or a combination thereof.

13. The system of claim 11, wherein the received acoustic waves comprise a first set of the acoustic waves during a first period of time and a second set of acoustic waves during a second period of time.

14. The system of claim 11, wherein determining at least one dynamic property of the at least one microbubble comprises implementing an algorithm that is independent from properties of the at least one microbubble.

15. The system of claim 14, wherein the oscillation of the at least one microbubble is one or more of linear oscillation, nonlinear oscillation, or a combination thereof, wherein the oscillation of the at least one microbubble causes a change in the radius of the at least one microbubble.

16. The system of claim 15, wherein the at least one memory module further comprises programmed instructions that, when executed by the controller, further causes the system to:
convert at least a portion of the acoustic emission data to a frequency domain;
determine, based at least in part on the acoustic emission data in the frequency domain, a pressure propagation of the at least one oscillating microbubble; and
determine, based at least in part on the pressure propagation, at least one oscillating microbubble radius change.

17. The system of claim 15, wherein the at least one memory module further comprises programmed instructions that, when executed by the controller, further causes the system to:
determine, based at least in part on the at least one oscillating microbubble radius change, an average pressure for at least one microbubble.

18. The system of claim 17, wherein the at least one memory module further comprises programmed instructions that, when executed by the controller, further causes the system to:
determine, based at least in part on a determination of the at least one oscillating microbubble radius change, the at least one dynamic property of the at least one microbubble.

19. The system of claim 11, wherein the at least one memory module further comprises programmed instructions that, when executed by the controller, further causes the system to:
identify one or more type of phase delay due to a spatial distribution of the at least one microbubble, wherein the one or more type of phase delay is due to one or more of a propagation source, propagation of the acoustic emission data, or a combination thereof.

20. The system of claim 11, wherein the at least one memory module further comprises programmed instructions that, when executed by the controller, further causes the system to:
position the waveform generator and at least one receiver opposite of each other, wherein a position of the waveform generator and the at least one receiver results in constructive propagation from the at least one microbubble.
